(19) United States
(12) Patent Application Publication
(10) Pub. No.: US 2012/0051831 A1
(43) Pub. Date: Mar. 1, 2012

(54) QUICK CONNECT COUPLING FOR CONCRETE REBAR

(76) Inventors: Louis Albert Waters, JR., Bellaire, TX (US); Robert Mahan Hardy, JR., Houston, TX (US)

(21) Appl. No.: 12/862,461

(22) Filed: Aug. 24, 2010

(51) Int. Cl. F16B 7/20; B23P 19/04

(52) U.S. Cl. 403/11; 403/349; 29/445

(57) ABSTRACT

Embodiments of the present invention generally relate to a method and an apparatus for connecting adjacent concrete structures. In one aspect, a coupling assembly for connecting adjacent concrete structures erected for street, roadway or highway use is provided. The coupling assembly includes a first anchor device with a female end comprising a socket having at least one slot. The coupling assembly further includes a second anchor device with a male end comprising at least one projection configured to mate with the at least one slot in the socket, wherein the second anchor device is movable from a first position to a second position in order to couple the male end to the female end. In another aspect, a method of coupling a first anchor device to a second anchor device is provided.

### BACKGROUND OF THE INVENTION

1. Field of the Invention

The invention generally relates to a method and an apparatus for connecting adjacent concrete structures used for roadways, streets and highways. More specifically, embodiments of the present invention relate to a method and an apparatus for attaching devices embedded in the adjacent concrete structures for the purpose of securely joining the concrete structures together into a unified road or highway with sufficient strength to prevent the structures from separating due to traffic and natural environmental conditions.

2. Description of the Related Art

Concrete streets, roads and highways are typically constructed in parallel concrete structures. These structures must be joined together to form the completed roadway. The conventional method for coupling the adjacent concrete structures into a single road or highway employs the use of a length of common reinforcing steel bars with a threaded coupling device attached to the end. These are used in pairs, with one bar having a female coupler, and the other bar a male coupler. Prior to placement of concrete to form the first structure, one of the bars is fixed at a location and height within the designed area of concrete placement, so that the bar portion is completely encased within the concrete. Immediately after the placement of the concrete, and prior to full hardening of the concrete, the coupler portion of the bar is located within the concrete, and the concrete around the coupler portion is removed in order to allow access to the coupler portion.

Prior to placement of the• concrete for the next adjacent concrete structure, the second portion of the coupler is attached by the threaded coupler device to the first bar embedded in the first concrete structure. Together these two bars, joined• by a threaded coupler, form a single bar that serves to prevent the two structures from separating in response to the natural forces of traffic and changing environmental conditions.

Prior to placement of concrete for the second structure, the workers remove the thread protectors from the bar portion embedded in the first concrete structure, and then manually thread the second bar into the threads of the first bar. Typically, the threading process involves simply starting the threading, and power tools, such as heavy duty drills, are used to complete the threading. This method of attaching the coupling bars presents several significant difficulties for assuring completion of the coupling joint. For example, there is no sure means by visual inspection to insure that all bars were finally seated after the initial threading start. A bar that may have been inadvertently skipped when using the power tool to firmly screw down the joints will appear no different from those that were properly completed. In another example, the initial threading start could have been cross threaded, which will then result in stripping of the threads during the power screw down. In either event, the strength of the coupling joint is lost, and there is no means of identifying this deficiency from a visual inspection. In a further example, the thread quality can be compromised by concrete and debris entering the connection and/or by rust.

Thus, the embodiments of the present invention are directed to a method and an apparatus that seek to overcome these difficulties and other limitations known in the art.

### SUMMARY OF THE INVENTION

Embodiments of the present invention generally relate to a method and an apparatus for connecting adjacent concrete structures. In one aspect, a coupling assembly for connecting adjacent concrete structures erected for street, roadway or highway use is provided. The coupling assembly includes a first anchor device with a female end comprising a socket having at least one slot. The coupling assembly further includes a second anchor device with a male end comprising at least one projection configured to mate with the at least one slot in the socket, wherein the second anchor device is movable from a first position to a second position in order to couple the male end to the female end.

In another aspect, a method of coupling a first anchor device to a second anchor device is provided. The method includes the step of inserting a male end of the second anchor device into a female end of the first anchor device. The method also includes the step of aligning a projection on the male end with a slot in the female end. Additionally, the method includes the step of moving the second anchor device from a first position to a second position, thereby causing the projection to mate with the slot.

In yet a further aspect, a coupling assembly for connecting adjacent concrete structures erected for street, roadway or highway use is provided. The coupling assembly includes a first anchor device having a female end comprising a socket with a first opening and a second opening. The coupling assembly further includes a second anchor device having a male end comprising at least one projection, wherein the male end of the second anchor device is configured to be inserted into the second opening of the socket and then rotated relative to the socket such that a portion of the male end engages the first opening.

Additionally, a method of coupling a first anchor device to a second anchor device is provided. The method includes the step of inserting a male end of the second anchor device into a second opening of a female end of the first anchor device. The method further includes the step of aligning a projection on the male end with a shaped portion in the female end. Additionally, the method includes the step of rotating the second anchor device relative to the first concrete bar such that a portion of the male end engages a first opening of the female end.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a quick connect coupling assembly in accordance with an embodiment of the invention.

FIG. 2 illustrates a cross-sectional view of a female end in the quick connect coupling assembly.

FIG. 3 illustrates a cross-sectional view of a male end in the quick connect coupling assembly.

FIG. 4 illustrates the quick connect coupling assembly.

FIG. 5 illustrates a cross-sectional view of the quick connect coupling assembly prior to rotation of the male end.

FIG. 6 illustrates a cross-sectional view of the quick connect coupling assembly after the rotation of the male end.

FIG. 7 illustrates a side view of a quick connect coupling assembly in accordance with a further embodiment of the invention.

FIG. 8 illustrates a top view of the quick connect coupling assembly.

FIGS. 9-12 illustrate the connection of the quick connect coupling assembly.

FIGS. 13-15 illustrate the connection of a quick connect coupling assembly in accordance with a further embodiment of the invention.

FIGS. 16-20 illustrate the connection of a quick connect coupling assembly in accordance with a further embodiment of the invention.

### DETAILED DESCRIPTION

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

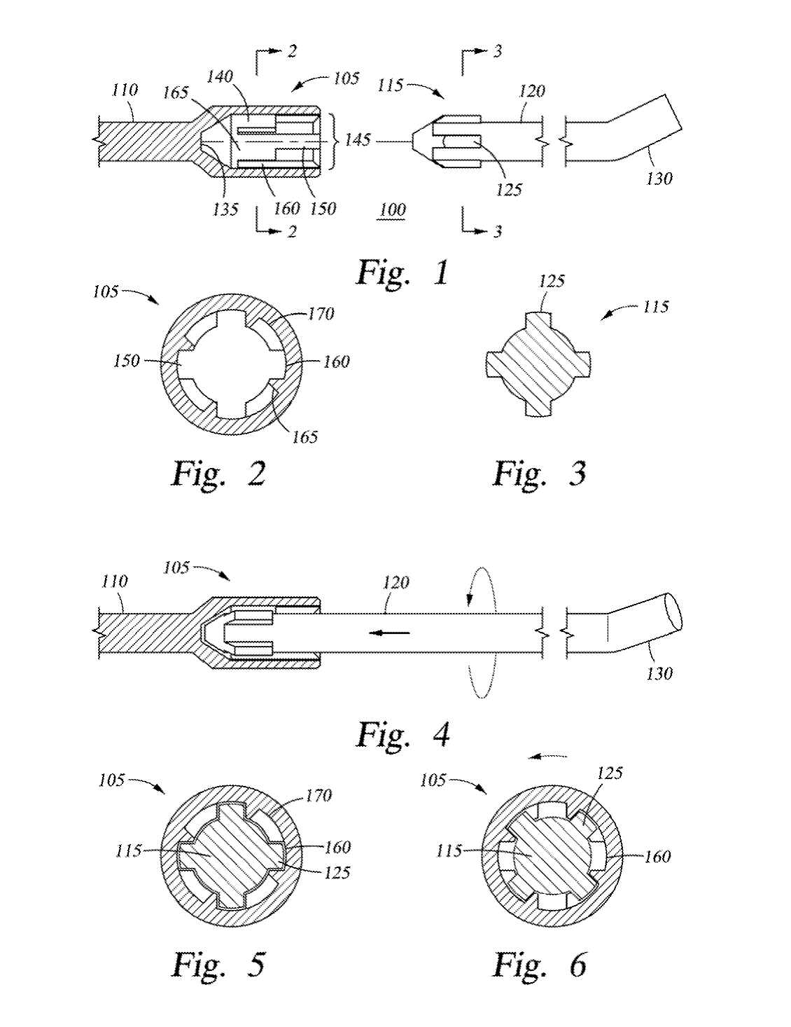

FIG. 1 is a view of a quick connect coupling assembly 100 in accordance with an embodiment of the invention. The quick connect coupling assembly 100 is configured to connect adjacent concrete structures. The concrete structures may be used in roadways, streets and highways. The coupling assembly 100 includes a first anchor device 110 with a female end 105 and a second anchor device 120 with a male end 115. Generally, the first anchor device 110 includes a portion that will be attached or embedded in one concrete structure (not shown), and the second anchor device 120 includes a portion that will be attached or embedded in another adjacent concrete structure (not shown). As illustrated, the second anchor device 120 is longitudinally aligned to the first anchor device 110. The male end 115 is attached to the second anchor device 120 and is configured to be inserted into the female end 105. The female end 105 is attached to the first anchor device 110 and comprises a socket 140. The socket 140 is configured to mate with the male end 115. For instance if the male end 115 has a tapered end, then the socket 140 of the female end 105 will be configured to mate with the tapered end of the male end 115. The socket 140 may have any suitable inner diameter. However, the socket 140 preferably has an inner diameter substantially the same as an outer diameter of the male end 115.

In certain embodiments, the male end 115 and the female end 105 are coupled using a bayonet mechanism or a bayonet-type coupling which will be described in more detail herein. Generally, a “bayonet mechanism” or a “bayonet coupling” means any connection involving a male end having at least one projection in which the male end engages with a female end which has corresponding slots that mate with the at least one projection. A bayonet mechanism usually involves inserting the male end into the female end and then rotating the male end no more than about 180° about a longitudinal axis of the coupling assembly in order to lock or secure the connection between the male end and the female end. It is generally designed for rapid coupling and decoupling, involving the turning of one part through only a small arc, as compared to a screw-type arrangement, which requires several full turns.

Generally, the male end 115 is inserted into the female end 105 in a first position. The male end 115 is then moved to a second position to fully engage female end 105. As such, securing the coupling assembly 100 typically entails the movement of the second anchor device 120 in a direction away from the first anchor device 110. Moreover, the second anchor device 120 is usually axially rotated in order to fully engage the male end 115 and the female end 105. As defined herein, “axially rotating” or “axial rotation” means rotating an element about its longitudinal axis. The degree of axial rotation required to secure the coupling assembly 100 varies depending on the locking mechanism (i.e. bayonet mechanism), incorporated into the male end 115 and the female end 105. The degree of rotation is no more than about 360°, typically no more than about 180°. In other embodiments, the second anchor device does not need to be axially rotated in order to fully engage the male end and the female end. It should be noted that the anchor devices 110, 120 in the coupling assembly 100 are connected without the use of threads or a threaded portion.

As illustrated in FIGS. 1 and 2, the socket 140 of the first anchor device 110 includes a plurality of slots 150 (or grooves) that correspond to a plurality of projections 125 on the male end 115. In one embodiment, at least one of the slots 150 has a longitudinal axis that is parallel to a longitudinal axis of the first anchor device 110. Between each pair of slots 150 is a lug that corresponds to the space between each pair of projections 125 on the male end 115. The socket 140 also includes a plurality of the recesses 160. The recesses 160 define a second set of recesses 165. A portion of each recess 165 is aligned with each slot 150 allowing the male end 115 to be inserted from a front portion to a back portion of the socket 140. Furthermore, each recess 165 has a width which is wider than the width of each slot 150. In addition, each recess 165 includes an arcuate surface 170 which allows the male end 115 to rotate in the socket 140 a predefined amount of degrees.

The male end 115 and the corresponding female end 105 comprise a bayonet mechanism capable of forming a locked connection by axially rotating the second anchor device 120 no more than about 180°. As shown in FIGS. 1 and 3, the male end 115 includes the projection 125. It should noted that the male end 115 may include any number of projections 125 without departing from principles of the present invention. In the embodiment illustrated in FIGS. 2-6, the male end 115 includes four projections 125. Generally, the projections 125 are evenly spaced around the perimeter of the male end 115. However, the projections may be in any configuration around the perimeter of the male end 115. Additionally, the projections 125 may be any type of projections known in the art, such as lugs, teeth, shoulders, tabs, pins, etc.

As shown in FIG. 1, the second anchor device 120 may optionally include an arm 130. Generally, the arm 130 allows a user to visually confirm that the second anchor device 120 is securely connected to the first anchor device 110 when the second anchor device 120 is rotated about its longitudinal axis upon locking the coupling assembly 100. Thus, as a user individually inspects each anchor device connection, the user can easily determine visually whether a secure connection has been made by examining the orientation of the arm 130. In one embodiment, the arm 130 may be a portion of the second anchor device 120 that has been bent at an angle. In another embodiment, the arm 130 may be a separate bar (not shown) that is coupled to the second anchor device 120. The arm 130 is typically perpendicular to the second anchor device 120. However, the arm 130 may be at any angle in relation to the second anchor device 120 without departing from principles of the present invention.

As set forth in FIG. 4, the male end 115 is axially aligned with the female end 105 such that the projections 125 are aligned with the slots 150. The male end 115 is then inserted through a socket opening 145 of the socket 140. As a user pushes the male end 115 through the socket 140, the male end 115 slides into the female end 105 until the tip of the male end 115 contacts an inner surface 135, signaling that the male end 115 is fully inserted into the socket 140. At this point, the user may rotate the second anchor device 120 using the arm 130 to secure the coupling assembly 100.

As illustrated in FIGS. 5 and 6, when the male end 115 is rotated about its longitudinal axis to a predetermined degree (i.e. 90°), the plurality of projections 125 contact the plurality of abutments 160 preventing further rotation. Moreover, in some embodiments, after the second anchor device 120 is rotated, the second anchor device 120 is pulled in a direction away from the first anchor device 110 such that the projections 125 slide into longitudinal recesses located in the female end 105 to further secure or lock the connection assembly 100. Thus, the first anchor device 110 is securely coupled with the second anchor device 120 when the second anchor device 120 is rotated about its longitudinal axis no more than about 180°.

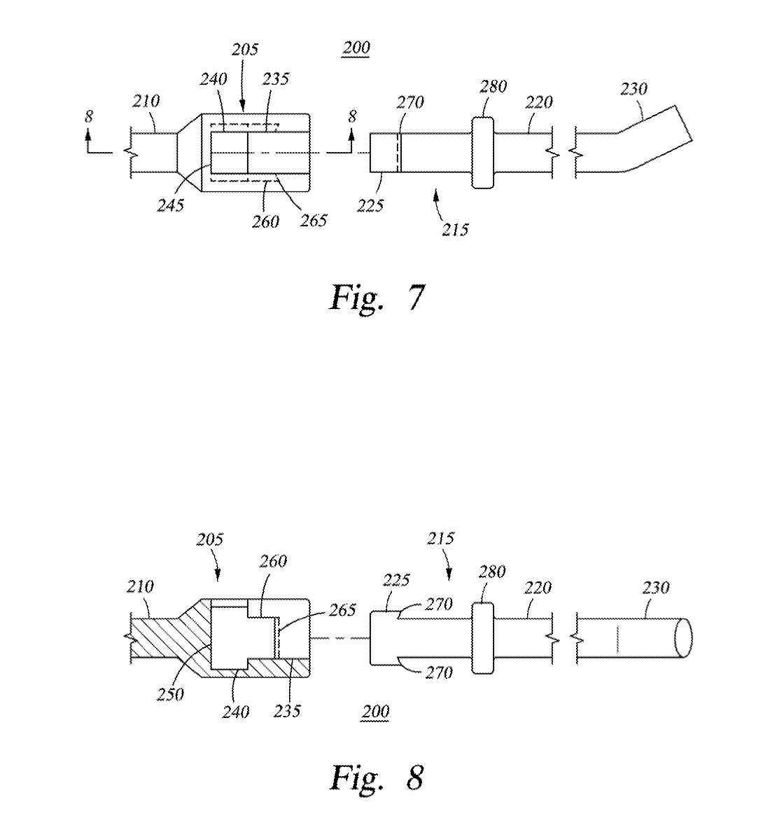

FIG. 7 is a side view and FIG. 8 is a top view of a quick connect coupling assembly 200 in accordance with a further embodiment of the invention. The quick connect coupling assembly 200 is configured to connect adjacent concrete structures. The concrete structures may be used in roadways, streets and highways. The coupling assembly 200 includes a first anchor device 210 with a female end 205 and a second anchor device 220 with a male end 215. Generally, the first anchor device 210 includes a portion that will be attached or embedded in one concrete structure (not shown), and the second anchor device 220 includes a portion that will be attached or embedded in another adjacent concrete structure (not shown). The male end 215 is configured to be inserted into the female end 205. The male end 215 includes at least one lateral projection 225, more preferably at least two projections 225. Each lateral projection 225 may include a shoulder 270. As shown in FIG. 8, the shoulders 270 are angled toward the back of the male end 215. However, it should be noted that the shoulders 270 may be angled in any suitable direction without departing from principles of the present invention. The male end 215 further includes an optional protective flange 280 (or the guard) to prevent dirt or residue from entering the coupling assembly 200.

The female end 205 includes a socket 250 that is adapted to fit the lateral projections 225 of the male end 215. As shown, the socket 250 includes an axial socket opening 245 located longitudinally along an outer surface of the female end 205. A first portion 235 of the socket 250 includes a plurality of longitudinal recesses 260 adapted to fit the lateral projections 225 of the male end 215. The recesses 260 are configured with bevels 265 that mate with the shoulders 270 of the lateral projections 225 in order to lock the male end 215 in the female end 205.

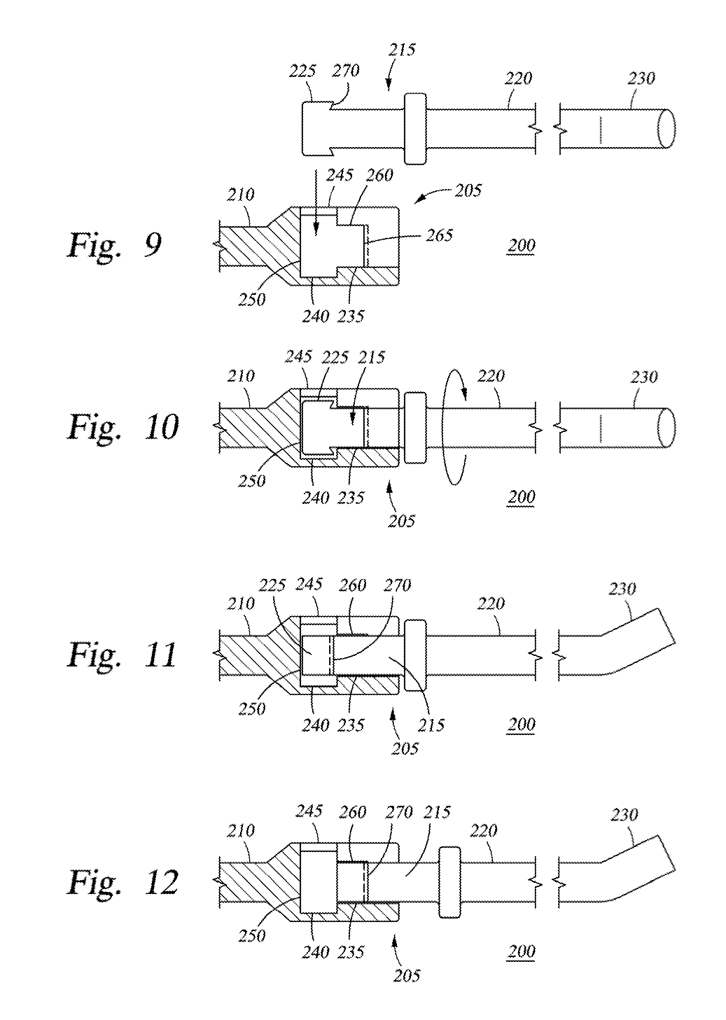

FIGS. 9-12 illustrate sequential steps in the connection of the quick connect coupling assembly 200. Generally, the male end 215 is inserted into the female end 205 in a first position and then moved to a second position to fully engage female end 205. As illustrated in FIG. 9, the male end 215 is inserted through the opening 245 into the socket 250 in a radial direction. In one embodiment, the socket opening 245 is configured such that the male end 215 may only be inserted with the lateral projections 225 substantially perpendicular to the opening 245. Moreover, the lateral projections 225 are only fully insertable at an end portion of the socket 250. As illustrated in FIG. 10, after the male end 215 is fully inserted into the socket 250 (i.e. the first position), the second anchor device 220 is rotated relative to the first anchor device 210 about its longitudinal axis (about 90 degrees). The second anchor device 220 may optionally include an arm 230 that allows a user to visually confirm that the second anchor device 220 is securely connected to the first anchor device 210. Thus, as the user individually inspects each rebar connection, the user can easily determine visually whether a secure connection has been made by examining the orientation of the arm 230. It should be noted that the anchor devices 210, 220 in the coupling assembly 200 are connected without the use of threads or a threaded portion.

As illustrated in FIGS. 11 and 12, after the second anchor device 220 is rotated, the second anchor device 220 is pulled in a direction away from the first anchor device 210. The axial movement of the second anchor device 220 relative to the first anchor device 210 causes the lateral projections 225 on the male end 215 to slide from a back portion 240 of the socket 250 to a front portion 235 and into the recesses 260 (i.e. the second position). At this point, the shoulders 270 of the lateral projections 225 on the male end 215 engage with the bevels 265 in the female end 205, thereby releasably locking the male end 215 to the female end 205 in the coupling assembly 200.

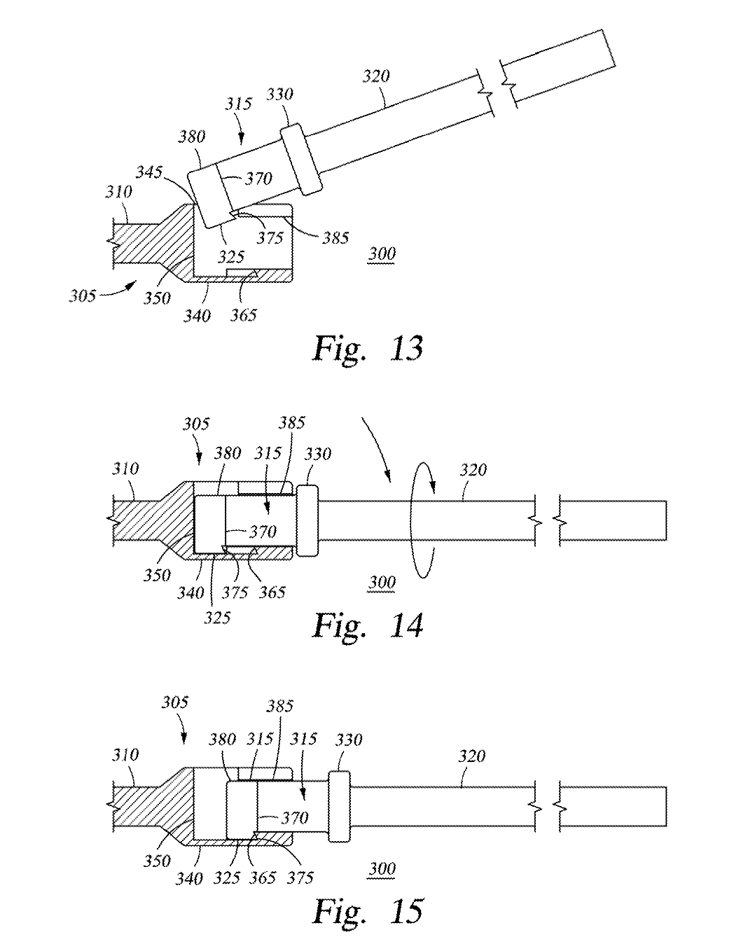

FIGS. 13-15 illustrate sequential steps in the connection of the quick connect coupling assembly 300 in accordance with a further embodiment of the invention. The quick connect coupling assembly 300 is configured to connect adjacent concrete structures. The concrete structures may be used in roadways, streets and highways. The coupling assembly 300 includes a first anchor device 310 with a female end 305 and a second anchor device 320 with a male end 315. Generally, the first anchor device 310 includes a portion that will be attached or embedded in one concrete structure (not shown), and the second anchor device 320 includes a portion that will be attached or embedded in another adjacent concrete structure (not shown). The male end 315 is configured to be inserted into the female end 305. The male end 315 includes a bottom lateral projection 325 with an angled shoulder 375 and two side lateral projections 380 with flat shoulders 370. In alternative embodiments, the side lateral projections 380 may also have angled shoulders (not shown) and the bottom lateral projection 325 may have a flat shoulder (not shown). The male end 315 may further include an optional protective flange 330 (or the guard) to prevent dirt or residue from entering the coupling assembly 300.

The female end 305 includes a socket 350 that is adapted to fit the lateral projections 325, 380 of the male end 315. As shown, the socket 350 includes an axial socket opening 345 located longitudinally along an outer surface of the female end 305. The socket 350 is configured such that the male end 315 may be inserted at an angle with respect to the socket opening 345. A front portion of the socket 350 includes a bevel 365 and a longitudinal recess 385 to engage the lateral projections 380, 325 of the male end 315.

As illustrated in FIG. 13, the male end 315 is inserted at an angle relative to the female end 305 through the socket opening 345 into the socket 350. The lateral projections 380, 325 are fully insertable only at a back portion 340 of the socket 350. As illustrated in FIG. 14, once the male end 315 is fully inserted, the second anchor device 320 is rotated about an axis substantially perpendicular to its longitudinal axis no more than 180°. As illustrated in FIG. 15, the second anchor device 320 is locked to secure the male end 315 in the female end 305 and form the coupling assembly 300. At this point, the angled shoulder 375 of bottom lateral projection 325 engages with the bevel 365 while at substantially the same time, the shoulders 370 of the side lateral projections 380 engage with the longitudinal recesses 385 to lock the coupling assembly 300. In one embodiment, the second anchor device 320 is moved relative to the first anchor device 310 to secure the male end 315 in the female end 305 and form the coupling assembly 300. It should be noted that the anchor devices 310, 320 in the coupling assembly 300 are connected without the use of threads or a threaded portion.

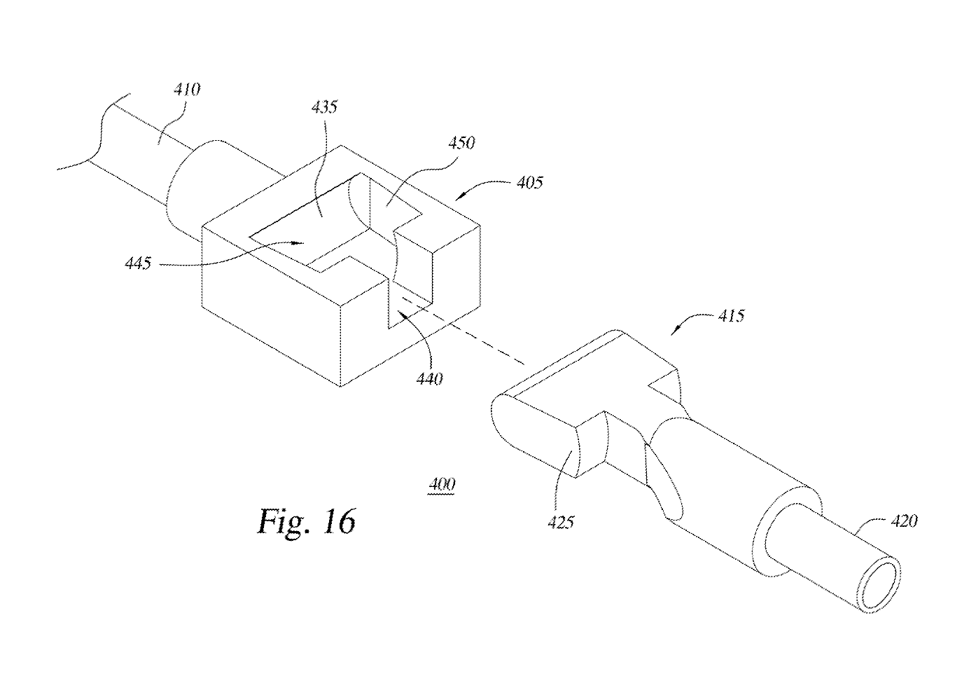

FIGS. 16-20 are views of a quick connect coupling assembly 400 in accordance with a further embodiment of the invention. The quick connect coupling assembly 400 is configured to connect adjacent concrete structures. The concrete structures may be used in roadways, streets and highways. The coupling assembly 400 includes a first anchor device 410 with a female end 405 and a second anchor device 420 with a male end 415. Generally, the first anchor device 410 includes a portion that will be attached or embedded in one concrete structure (not shown), and the second anchor device 420 includes a portion that will be attached or embedded in another adjacent concrete structure (not shown). The male end 415 is attached to the second anchor device 420 and the male end 415 is configured to be inserted into the female end 405. The female end 405 is attached to the first anchor device 410. The female end 405 includes a socket 440 that is configured to mate with the male end 415. For instance if the male end 415 has a tapered end, then the socket 440 of the female end 405 will be configured to mate with the tapered end of the male end 415. The socket 440 may have any suitable inner diameter. However, the socket 440 preferably has an inner diameter substantially the same as an outer diameter of the male end 415.

As illustrated in FIG. 16, the socket 440 of the first anchor device 410 includes at least one of slot 450 (or groove) that corresponds to projections 425 on the male end 415. In one embodiment, the slot 450 has a longitudinal axis that is perpendicular to a longitudinal axis of the first anchor device 410. It should noted that the male end 415 may include any number of projections 425 without departing from principles of the present invention. In the embodiment illustrated in FIG. 16, the male end 415 includes two projections 425. Generally, the projections 425 are spaced around the perimeter of the male end 415. However, the projections may be in any configuration around the perimeter of the male end 415. Additionally, the projections 425 may be any type of projections known in the art, such as lugs, teeth, shoulders, tabs, pins, etc.

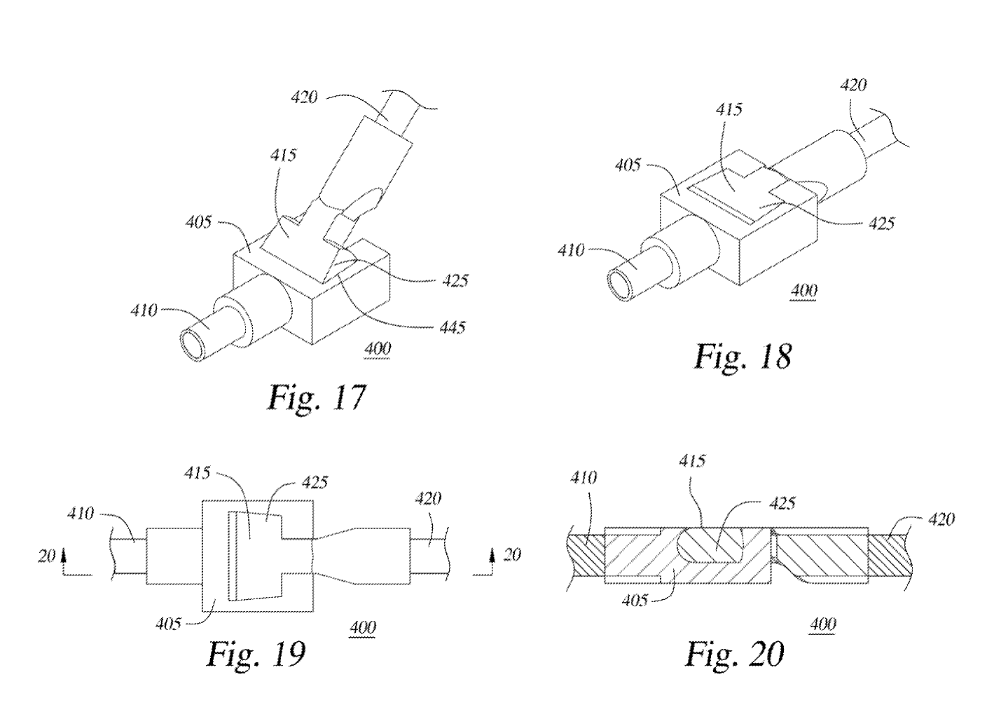

As shown in FIG. 17, the male end 415 is inserted into the female end 405 at an angle, such as 45°. More specifically, the male end 415 is inserted through a socket opening 445 (i.e. top opening) of the socket 440. As a user pushes the male end 415 into the socket 440, the male end 415 slides into the female end 405 until the tip of the male end 415 contacts an inner surface 435, signaling that the male end 415 is fully inserted into the socket 440. At this point, the male end 415 is rotated relative to the female end 405 to engage the female end 405 as shown in FIGS. 17 and 18 such that a portion of the male end 415 engages a front opening of the socket 440. As illustrated, the first anchor device 410 is attached to the socket 440 on a side opposite the front opening. It should be noted that securing the coupling assembly 400 typically entails the movement of the second anchor device 420 relative to the first anchor device 410.

As set forth in FIG. 18, the male end 415 is axially aligned with the female end 405 such that the projections 425 are engaged with the slot 450. FIG. 19 is a top view of the coupling assembly 400. FIG. 20 is a sectional view taken along lines 20-20 of FIG. 19. As shown in FIG. 20, the male end 415 of the second anchor device 420 is fully engaged with the female end 405 of the first anchor device 410. It should be noted that the anchor devices 410, 420 in the coupling assembly 400 are connected without the use of threads or a threaded portion.

In reference to FIGS. 1-20, the female end and the male end of the first and the second anchor devices are typically manufactured by casting or cold-forming. However, any suitable manufacturing methods may be used to fabricate the male and female ends. In one embodiment, the coupling assembly formed between the female end and the male end is at least 1.2 times to about 2 times stronger than the tensile strength of a standard anchor device.

The first and the second anchor devices may be attached to additional anchor devices by any suitable methods known in the art, such as welding, wiring, screws, etc. Each anchor device may comprise a deformed steel bar that is attached or embedded in a concrete structure. The first and the second anchor devices are typically made of steel. However, the first and the second anchor devices may be made of any metal or structural material known in the art, such an alloy, iron, composites, etc. Further, the first and the second anchor devices typically have a cylindrical cross-section. In other embodiments, the first and the second anchor devices may have any geometrical cross-section, such as rectangular, triangular, etc.

Additionally, the male and female ends are typically affixed to the first and the second anchor devices by welding, casting, crimping, or other methods known to one of skill in the art. In some embodiments, the male end has a tapered end. In other embodiments, the male end has a blunt end. Furthermore, the female end typically has an outer diameter greater than an outer diameter of the first anchor device. However, in an alternative embodiment, the female end may have an outer diameter substantially equal to the outer diameter of the first anchor device such that the female end is flush with the first anchor device. Further, the concrete structures that are connected by the quick connect coupling assembly may include concrete reinforcement bars, such as a rebar mat, or the concrete structures may be a structure without any concrete reinforcement bars.

In another embodiment, a quick connect coupling assembly may include a first anchor device with a first shaped end and a second anchor device with a second shaped end. The first shaped end and the second shaped end are constructed and arranged to mate together to form the coupling assembly. It should be noted that neither the first shaped end nor the second shaped end is arranged as a male end or a female end as in the other embodiments set forth herein. The first and second shaped ends include mating shaped surfaces that engage upon contact or by rotating one of the anchor devices relative to the other anchor device. The first and second shaped ends may be complementary opposites. For instance, each shaped end may include a semi-circular outer surface with a curved inner surface that is configured to mate with the other complementary opposite shaped end. The first and second shaped ends may be identical. For instance, each shaped end may include a cylinder shape with a flat end face having a plurality of protrusions and a plurality of holes that mate the other identical shaped end. Even though, the first and second shaped ends have been described as semi-circular or cylindrical, it should be understood, however, that the first and second shaped ends may be any number geometrical shapes without departing from principles of the present invention. Similar to other embodiments, the coupling assembly is configured to connect adjacent concrete structures. The concrete structures may be used in roadways, streets and highways. The first anchor device includes a portion that will be attached or embedded in one concrete structure, and the second anchor device includes a portion that will be attached or embedded in another adjacent concrete structure.

While the foregoing is directed to embodiments of the present invention, other and further embodiments of the invention may be devised without departing from the basic scope thereof, and the scope thereof is determined by the claims that follow.

1. A coupling assembly for connecting adjacent concrete structures erected for street, roadway or highway use, the coupling assembly comprising:
a first anchor device with a female end comprising a socket having at least one slot; and
a second anchor device with a male end comprising at least one projection configured to mate with the at least one slot in the socket, wherein the second anchor device is movable from a first position to a second position in order to couple the male end to the female end.

2. The assembly of claim 1, wherein the second anchor device includes an indicator member configured to indicate that the second anchor device has been moved from the first position to the second position.

3. The assembly of claim 2, wherein the indicator member is an end portion of the second anchor device which has been bent at an angle.

4. The assembly of claim 2, wherein the indicator member is a separate piece that is attached to the second anchor device.

5. The assembly of claim 1, wherein the at least one slot has a longitudinal axis that is parallel to a longitudinal axis of the first anchor device.

6. The assembly of claim 1, wherein the socket has a socket opening at an end portion to allow the male end to be axially inserted into the female end.

7. The assembly of claim 1, wherein the socket has a socket opening on a side portion to allow the male end to be inserted into the female end at an angle.

8. The assembly of claim 1, wherein each projection includes a shoulder that mates with a corresponding shoulder on each slot.

9. The assembly of claim 1, wherein the socket further comprises at least one recess proximate a back portion of the socket and wherein the at least one recess defines at least one abutment.

10. The assembly of claim 9, wherein the at least one recess comprises an arcuate surface.

11. A method of coupling a first anchor device to a second anchor device, the method comprising:
inserting a male end of the second anchor device into a female end of the first anchor device;
aligning a projection on the male end with a slot in the female end; and
moving the second anchor device from a first position to a second position, thereby causing the projection to mate with the slot.

12. The method of claim 11, further comprising indicating that the projection on the male end has mated with the slot on the female end.

13. The method of claim 11, wherein moving the second anchor device from the first position to the second position comprises rotating the second anchor device relative to the first anchor device.

14. The method of claim 11, wherein the slot has a longitudinal axis that is parallel to a longitudinal axis of the first anchor device.

15. The method of claim 11, wherein the male end is inserted into the female end along a longitudinal axis of the first anchor device.

16. The method of claim 11, wherein the male end is inserted into the female end at an angle relative to a longitudinal axis of the first anchor device.

17. A coupling assembly for connecting adjacent concrete structures erected for street, roadway or highway use, the coupling assembly comprising:
a first anchor device having a female end comprising a socket with a first opening and a second opening; and
a second anchor device having a male end comprising at least one projection, wherein the male end of the second anchor device is configured to be inserted into the second opening of the socket and then rotated relative to the socket such that a portion of the male end engages the first opening.

18. The coupling assembly of claim 17, wherein the at least one projection is configured in the shape of the second opening of the socket.

19. The coupling assembly of claim 17, wherein the first anchor device is attached to the socket on a side opposite the first opening.

20. The coupling assembly of claim 17, wherein the first opening is a front opening and the second opening is a top opening.

21. A method of coupling a first anchor device to a second anchor device, the method comprising:
inserting a male end of the second anchor device into a second opening of a female end of the first anchor device;
aligning a projection on the male end with a shaped portion in the female end; and
rotating the second anchor device relative to the first anchor device such that a portion of the male end engages a first opening of the female end.

22. A coupling assembly for connecting adjacent concrete structures erected for street, roadway or highway use, the coupling assembly comprising:
a first anchor device with a first shaped end comprising a semi-circular outer
a second anchor device with a second shaped end comprising a semi-circular outer surface with a curved inner surface, wherein the second anchor device is movable from a first position to a second position in order to couple the first shaped end to the second shaped end.
